(19) United States
(12) Patent Application Publication
(10) Pub. No.: US 2024/0340890 A1
(43) Pub. Date: Oct. 10, 2024

(54) DOWNLINK CONTROL CHANNEL CAPACITY ENHANCEMENTS FOR NON-TERRESTRIAL NETWORKS

(71) Applicant: QUALCOMM Incorporated, San Diego, CA (US)

(72) Inventors: Ayan SENGUPTA, San Diego, CA (US); Alberto RICO ALVARINO, San Diego, CA (US); Le LIU, San Jose, CA (US); Xiao Feng WANG, San Diego, CA (US); Syed Hashim Ali SHAH, San Diego, CA (US)

(21) Appl. No.: 18/625,011

(22) Filed: Apr. 2, 2024

Related U.S. Application Data
(60) Provisional application No. 63/494,743, filed on Apr. 6, 2023.

(51) Int. Cl. H04W 72/1268; H04L 1/00; H04L 1/1812; H04W 8/22

(52) U.S. Cl. CPC H04W 72/1268; H04L 1/0071; H04L 1/1812; H04W 8/22

(57) ABSTRACT

Methods, systems, and devices for wireless communications are described. A user equipment (UE) may receive a grant scheduling a multi-transport block uplink transmission by the UE, the multi-transport block uplink transmission comprising two or more transport blocks associated with a common hybrid automatic repeat/request process identifier. The UE may perform the multi-transport block uplink transmission according to the grant.

### CROSS REFERENCE

The present Application for Patent claims the benefit of U.S. Provisional Patent Application No. 63/494,743 by SENGUPTA et al., entitled “DOWNLINK CONTROL CHANNEL CAPACITY ENHANCEMENTS FOR NON-TERRESTRIAL NETWORKS,” filed Apr. 6, 2023, assigned to the assignee hereof, and expressly incorporated by reference herein.

### FIELD OF TECHNOLOGY

The following relates to wireless communications, including downlink control channel capacity enhancements for non-terrestrial networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support downlink control channel capacity enhancements for non-terrestrial networks (NTNs). For example, the described techniques provide for improved methods, systems, devices, and apparatuses that support enhanced uplink control channel capacity, such as when scheduling multiplexed uplink transmissions from user equipment (UE). A network entity transmits a grant to a UE that schedules a multi-transport block (TB) uplink transmission. The multi-TB uplink transmission may include two or more TBs being scheduled for the same (e.g., a common) hybrid automatic repeat/request (HARQ) process identifier. That is, the single grant may schedule uplink TB transmissions for one or more HARQ process identifiers. The grant may schedule, for at least one of the HARQ process identifiers indicated in the grant, two or more TBs to be transmitted by the UE during the multiplexed uplink transmission. The common HARQ process identifier may be associated with a feedback-less HARQ process (e.g., the UE may not expect HARQ feedback for the multiple TBs scheduled by the grant). The UE may perform the multi-TB uplink transmission to the network entity (e.g., via a NTN or a terrestrial network (TN)) according to the grant.

A method for wireless communications at a UE is described. The method may include receiving a grant scheduling a multi-TB uplink transmission by the UE, the multi-TB uplink transmission including two or more TBs associated with a common HARQ process identifier and performing the multi-TB uplink transmission according to the grant.

An apparatus for wireless communications at a UE is described. The apparatus may include a processor, memory coupled with the processor, and instructions stored in the memory. The instructions may be executable by the processor to cause the apparatus to receive a grant scheduling a multi-TB uplink transmission by the UE, the multi-TB uplink transmission including two or more TBs associated with a common HARQ process identifier and perform the multi-TB uplink transmission according to the grant.

Another apparatus for wireless communications at a UE is described. The apparatus may include means for receiving a grant scheduling a multi-TB uplink transmission by the UE, the multi-TB uplink transmission including two or more TBs associated with a common HARQ process identifier and means for performing the multi-TB uplink transmission according to the grant.

A non-transitory computer-readable medium storing code for wireless communications at a UE is described. The code may include instructions executable by a processor to receive a grant scheduling a multi-TB uplink transmission by the UE, the multi-TB uplink transmission including two or more TBs associated with a common HARQ process identifier and perform the multi-TB uplink transmission according to the grant.

In some examples of the method, apparatuses, and non-transitory computer-readable medium described herein, identifying, based on the grant, the two or more TBs for the common HARQ process identifier and at least an additional TB for a different HARQ process identifier.

Some examples of the method, apparatuses, and non-transitory computer-readable medium described herein may further include operations, features, means, or instructions for applying, based on the grant, a time gap between successive transmissions of the two or more TBs during the multi-TB uplink transmission.

In some examples of the method, apparatuses, and non-transitory computer-readable medium described herein, a presence, a duration, or both, of the time gap may be based on at least one of a UE capability reported by the UE, an access technology associated with the multi-TB uplink transmission, a number of repetitions scheduled for at least one of the two or more TBs, or a combination thereof.

In some examples of the method, apparatuses, and non-transitory computer-readable medium described herein, identifying, based on the grant, an interleaving pattern defined across one or more repetitions of at least the two or more TBs across a time domain, where performing the multi-TB uplink transmission includes transmitting the one or more repetitions of at least the two or more TBs according to the interleaving pattern.

In some examples of the method, apparatuses, and non-transitory computer-readable medium described herein, the grant includes a UE-specific downlink control information (DCI) grant to the UE.

A method for wireless communications at a UE is described. The method may include receiving a group common grant scheduling an uplink transmission of a TB for the UE and at least a second uplink transmission of a second TB for a second UE and performing the uplink transmission according to the group common grant.

An apparatus for wireless communications at a UE is described. The apparatus may include a processor, memory coupled with the processor, and instructions stored in the memory. The instructions may be executable by the processor to cause the apparatus to receive a group common grant scheduling an uplink transmission of a TB for the UE and at least a second uplink transmission of a second TB for a second UE and perform the uplink transmission according to the group common grant.

Another apparatus for wireless communications at a UE is described. The apparatus may include means for receiving a group common grant scheduling an uplink transmission of a TB for the UE and at least a second uplink transmission of a second TB for a second UE and means for performing the uplink transmission according to the group common grant.

A non-transitory computer-readable medium storing code for wireless communications at a UE is described. The code may include instructions executable by a processor to receive a group common grant scheduling an uplink transmission of a TB for the UE and at least a second uplink transmission of a second TB for a second UE and perform the uplink transmission according to the group common grant.

In some examples of the method, apparatuses, and non-transitory computer-readable medium described herein, identifying, based on the group common grant, one or more parameters common to at least the UE and the second UE, one or more UE-specific parameters, or both, for the uplink transmission by the UE and the second uplink transmission by the second UE.

Some examples of the method, apparatuses, and non-transitory computer-readable medium described herein may further include operations, features, means, or instructions for determining a configured shared identifier associated with at least the UE and the second UE and decoding the group common grant based on the configured shared identifier.

Some examples of the method, apparatuses, and non-transitory computer-readable medium described herein may further include operations, features, means, or instructions for receiving at least one of an initial radio resource control (RRC) signaling, a reconfiguration RRC signaling, a medium access control-control element (MAC-CE) signaling, or a combination thereof, that configures the configured shared identifier.

In some examples of the method, apparatuses, and non-transitory computer-readable medium described herein, the uplink transmission scheduled for the UE, the second uplink transmission scheduled for the second UE, or both, include a multi-TB uplink transmission comprising two or more TBs, the multi-TB uplink transmission associated with a common HARQ process identifier.

A method for wireless communications at a network entity is described. The method may include transmitting, to a UE, a grant scheduling a multi-TB uplink transmission by the UE, the multi-TB uplink transmission including two or more TBs associated with a common HARQ process identifier and receiving the multi-TB uplink transmission from the UE according to the grant.

An apparatus for wireless communications at a network entity is described. The apparatus may include a processor, memory coupled with the processor, and instructions stored in the memory. The instructions may be executable by the processor to cause the apparatus to transmit, to a UE, a grant scheduling a multi-TB uplink transmission by the UE, the multi-TB uplink transmission including two or more TBs associated with a common HARQ process identifier and receive the multi-TB uplink transmission from the UE according to the grant.

Another apparatus for wireless communications at a network entity is described. The apparatus may include means for transmitting, to a UE, a grant scheduling a multi-TB uplink transmission by the UE, the multi-TB uplink transmission including two or more TBs associated with a common HARQ process identifier and means for receiving the multi-TB uplink transmission from the UE according to the grant.

A non-transitory computer-readable medium storing code for wireless communications at a network entity is described. The code may include instructions executable by a processor to transmit, to a UE, a grant scheduling a multi-TB uplink transmission by the UE, the multi-TB uplink transmission including two or more TBs associated with a common HARQ process identifier and receive the multi-TB uplink transmission from the UE according to the grant.

Some examples of the method, apparatuses, and non-transitory computer-readable medium described herein may further include operations, features, means, or instructions for indicating, in the grant, the two or more TBs for the common HARQ process identifier and at least an additional TB for a different HARQ process identifier.

Some examples of the method, apparatuses, and non-transitory computer-readable medium described herein may further include operations, features, means, or instructions for indicating, in the grant, a time gap between UE transmissions of the two or more TBs during the multi-TB uplink transmission.

In some examples of the method, apparatuses, and non-transitory computer-readable medium described herein, a presence, a duration, or both, of the time gap may be based on at least one of a UE capability reported by the UE, an access technology associated with the multi-TB uplink transmission, a number of repetitions scheduled for at least one of the two or more TBs, or a combination thereof.

Some examples of the method, apparatuses, and non-transitory computer-readable medium described herein may further include operations, features, means, or instructions for indicating, in the grant, an interleaving pattern defined across one or more repetitions of at least the two or more TBs across a time domain, where receiving the multi-TB uplink transmission includes receiving the one or more repetitions of at least the two or more TBs according to the interleaving pattern.

In some examples of the method, apparatuses, and non-transitory computer-readable medium described herein, the grant includes a UE-specific DCI grant to the UE.

A method for wireless communications at a network entity is described. The method may include transmitting a group common grant scheduling an uplink transmission of a TB for a UE and at least a second uplink transmission of a second TB for a second UE and receiving the uplink transmission and the second uplink transmission according to the group common grant.

An apparatus for wireless communications at a network entity is described. The apparatus may include a processor, memory coupled with the processor, and instructions stored in the memory. The instructions may be executable by the processor to cause the apparatus to transmit a group common grant scheduling an uplink transmission of a TB for a UE and at least a second uplink transmission of a second TB for a second UE and receive the uplink transmission and the second uplink transmission according to the group common grant.

Another apparatus for wireless communications at a network entity is described. The apparatus may include means for transmitting a group common grant scheduling an uplink transmission of a TB for a UE and at least a second uplink transmission of a second TB for a second UE and means for receiving the uplink transmission and the second uplink transmission according to the group common grant.

A non-transitory computer-readable medium storing code for wireless communications at a network entity is described. The code may include instructions executable by a processor to transmit a group common grant scheduling an uplink transmission of a TB for a UE and at least a second uplink transmission of a second TB for a second UE and receive the uplink transmission and the second uplink transmission according to the group common grant.

Some examples of the method, apparatuses, and non-transitory computer-readable medium described herein may further include operations, features, means, or instructions for indicating, in the group common grant, one or more parameters common to at least the UE and the second UE, one or more UE-specific parameters, or both, for the uplink transmission by the UE and the second uplink transmission by the second UE.

Some examples of the method, apparatuses, and non-transitory computer-readable medium described herein may further include operations, features, means, or instructions for determining a configured shared identifier associated with at least the UE and the second UE and applying the configured shared identifier when transmitting the group common grant.

Some examples of the method, apparatuses, and non-transitory computer-readable medium described herein may further include operations, features, means, or instructions for transmitting at least one of an initial RRC signaling, a reconfiguration RRC signaling, a medium access control-control element (MAC-CE) signaling, or a combination thereof, that configures the configured shared identifier.

In some examples of the method, apparatuses, and non-transitory computer-readable medium described herein, the uplink transmission scheduled for the UE, the second uplink transmission scheduled for the second UE, or both, include a multi-TB uplink transmission comprising two or more TBs, the multi-TB uplink transmission associated with a common HARQ process identifier.

### BRIEF DESCRIPTION OF THE DRAWINGS

FIG. 1 shows an example of a wireless communications system that supports downlink control channel capacity enhancements for non-terrestrial networks (NTNs) in accordance with one or more aspects of the present disclosure.

FIG. 2 shows an example of a wireless communications system that supports downlink control channel capacity enhancements for NTNs in accordance with one or more aspects of the present disclosure.

FIG. 3 shows an example of an allocation scheme that supports downlink control channel capacity enhancements for NTNs in accordance with one or more aspects of the present disclosure.

FIG. 4 shows an example of an allocation scheme that supports downlink control channel capacity enhancements for NTNs in accordance with one or more aspects of the present disclosure.

FIG. 5 shows an example of an allocation scheme that supports downlink control channel capacity enhancements for NTNs in accordance with one or more aspects of the present disclosure.

FIGS. 6 and 7 show block diagrams of devices that support downlink control channel capacity enhancements for NTNs in accordance with one or more aspects of the present disclosure.

FIG. 8 shows a block diagram of a communications manager that supports downlink control channel capacity enhancements for NTNs in accordance with one or more aspects of the present disclosure.

FIG. 9 shows a diagram of a system including a device that supports downlink control channel capacity enhancements for NTNs in accordance with one or more aspects of the present disclosure.

FIGS. 10 and 11 show block diagrams of devices that support downlink control channel capacity enhancements for NTNs in accordance with one or more aspects of the present disclosure.

FIG. 12 shows a block diagram of a communications manager that supports downlink control channel capacity enhancements for NTNs in accordance with one or more aspects of the present disclosure.

FIG. 13 shows a diagram of a system including a device that supports downlink control channel capacity enhancements for NTNs in accordance with one or more aspects of the present disclosure.

FIGS. 14 through 17 show flowcharts illustrating methods that support downlink control channel capacity enhancements for NTNs in accordance with one or more aspects of the present disclosure.

### DETAILED DESCRIPTION

Wireless networks may support enhanced uplink capacity techniques to maximize resource usage. This may include the network multiplexing uplink transmissions from user equipment (UE) in the time domain, frequency domain, spatial domain, and/or code domain. Such networks generally separately schedule each UE via a control channel grant that identifies the resources for that particular UE, as well as other information to be applied by the UE during the uplink transmission. However, the resource utilization required to schedule each UE separately may mitigate gains achieved by multiplexing the uplink transmissions from multiple UEs. That is, the control signaling (e.g., carrying the grant) required to schedule each UE separately for multiplexed uplink transmissions may negate some of the resource conservation gains achieved by multiplexing the UEs. Some networks, such as a non-terrestrial network (NTN), may have less available resources than terrestrial networks, which may further compound inefficiencies of the necessary control channel resources used to schedule each UE.

Accordingly, aspects of the described techniques relate to improved methods, systems, devices, and apparatuses that support enhanced uplink control channel capacity, such as when scheduling multiplexed uplink transmissions from UE. A network entity transmits a grant to a UE that schedules a multi-transport block (TB) uplink transmission. The multi-TB uplink transmission may include two or more TBs being scheduled for the same (e.g., a common) hybrid automatic repeat/request (HARQ) process identifier. That is, the single grant may schedule uplink TB transmissions for one or more HARQ process identifiers. The grant may schedule, for at least one of the HARQ process identifiers indicated in the grant, two or more TBs to be transmitted by the UE during the multiplexed uplink transmission. The common HARQ process identifier may be associated with a feedback-less HARQ process (e.g., the UE may not expect HARQ feedback for the multiple TBs scheduled by the grant). The UE may perform the multi-TB uplink transmission to the network entity (e.g., via a NTN or a terrestrial network (TN)) according to the grant.

Aspects of the disclosure are initially described in the context of wireless communications systems. Aspects of the disclosure are further illustrated by and described with reference to apparatus diagrams, system diagrams, and flowcharts that relate to downlink control channel capacity enhancements for NTNs.

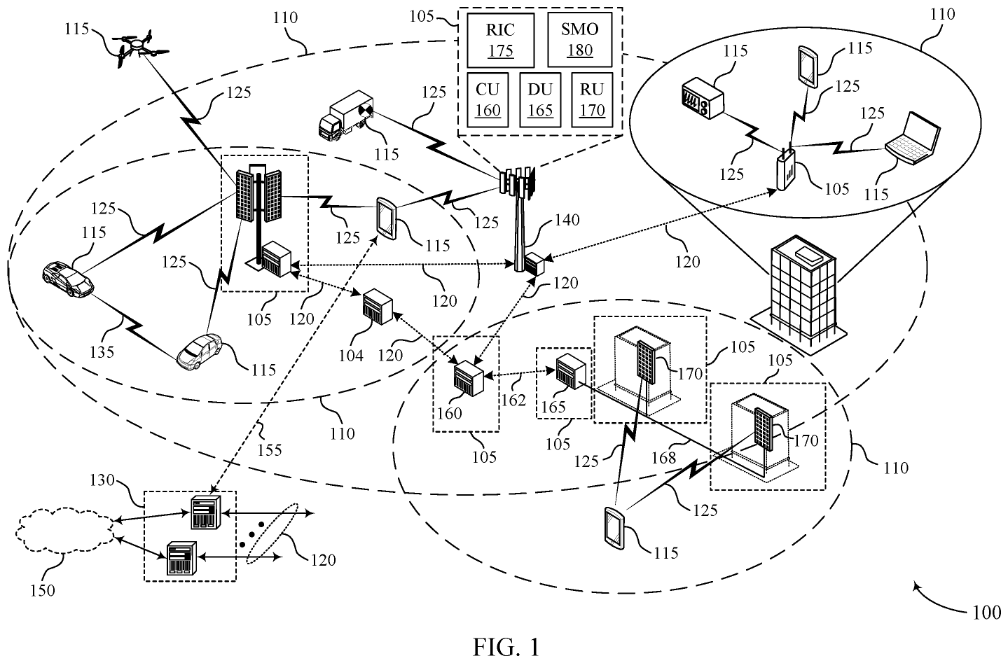

FIG. 1 shows an example of a wireless communications system 100 that supports downlink control channel capacity enhancements for NTNs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support downlink control channel capacity enhancements for NTNs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat/request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive a grant scheduling a multi-TB uplink transmission by the UE 115, the multi-TB uplink transmission comprising two or more TBs associated with a common HARQ process identifier. The UE 115 may perform the multi-TB uplink transmission according to the grant.

A UE 115 may receive a group common grant scheduling an uplink transmission of a TB for the UE 115 and at least a second uplink transmission of a second TB for a second UE 115. The UE 115 may perform the uplink transmission according to the group common grant.

A network entity 105 may transmit, to a UE 115, a grant scheduling a multi-TB uplink transmission by the UE 115, the multi-TB uplink transmission comprising two or more TBs associated with a common HARQ process identifier. The network entity 105 may receive the multi-TB uplink transmission from the UE 115 according to the grant.

A network entity 105 may transmit a group common grant scheduling an uplink transmission of a TB for a UE 115 and at least a second uplink transmission of a second TB for a second UE. The network entity 105 may receive the uplink transmission and the second uplink transmission according to the group common grant.

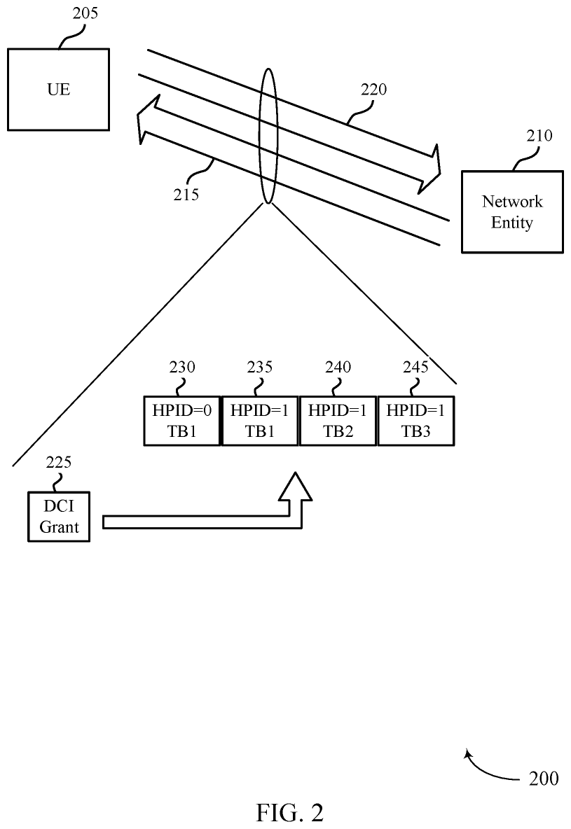

FIG. 2 shows an example of a wireless communications system 200 that supports downlink control channel capacity enhancements for NTNs in accordance with one or more aspects of the present disclosure. Wireless communications system 200 may implement aspects of wireless communications system 100. Wireless communications system 200 may include a UE 205 and/or a network entity 210, which may be examples of the corresponding devices described herein.

Wireless networks (such as wireless communications system 200) may support increasing the uplink capacity in terms of the number of UEs that can be multiplexed in a time/frequency resource, such as for NTNs, for TNs, or both. This may, in some examples, be based on the NTN spectrum being very scarce. Accordingly, maximum uplink spectral efficiency (especially at low uplink link budgets/signal-to-noise ratios (SNRs)) is supported, such as to scale NTN-based service to the maximum number of users. Examples of increasing the uplink capacity may include, but are not limited to, using orthogonal cover codes across repetitions, non-orthogonal multiple access, and others. However, these techniques come at the cost of increased downlink control overhead since each UE must be scheduled individually in a dedicated time/frequency resource in the downlink. This may potentially increase the downlink control overhead, thus reducing the downlink capacity of the wireless network.

As one non-limiting example, if M UEs can be multiplexed per unit of frequency resource (e.g., per subcarrier) for narrowband physical uplink shared channel (NPUSCH), the narrowband physical downlink control channel (NPDCCH) required to schedule these M UEs would natively use M times the downlink control channel overhead. In some examples, M=4 may be supportable for NPUSCH. The downlink grants (e.g., downlink control information (DCI) grants) cannot be stacked on top of each other in the same time/frequency resource since the network entity has a fixed amount of power that it transmits in each symbol. Depending on traffic patterns (e.g., large-vs-small uplink data chunks), the value of M in a given setting, etc., this control overhead for NPDCCH (DCI) may become prohibitive.

Accordingly, aspects of the techniques described herein provide for various techniques to reduce NPDCCH (e.g., the downlink DCI-based grant, or more simply a grant) overhead for such capacity-enhanced NPUSCH transmission scenarios. In some aspects, this may include enhanced multi-TB scheduling for a single UE, exploiting feedback-less HARQ processes. In some networks, in multi-TB scheduling, the network can only schedule a single instance of each TB by a DCI for a given HARQ process identifier, since the design assumes all TBs have HARQ-ACK feedback enabled. For NB-IoT, this may allow scheduling one instance (e.g., one TB) for each of the two HARQ processes scheduled by a given DCI. However, this approach only provides a doubling (e.g., ×2) multiplexing gain for NPDCCH at the cost of a small number of extra DCI bits. However, with feedback-less HARQ processes, multiple instances (e.g., multiple TBs) of or otherwise associated with the same HARQ process may be scheduled by a single DCI. In some examples, HARQ feedback may be disabled for that process. This may enable improved DCI multiplexing gain for a few additional DCI bits and/or a newly designed DCI, such as in terms of the DCI fields, bits, etc. As one non-limiting example regarding the additional DCI bits in eMTC, with 6 extra DCI bits, this may support increasing the multiplexing from one TB per DCI to eight TBs per DCI. The techniques described herein are not limited to eight TBs per DCI.

This may include the network entity 210 transmitting or otherwise providing (and the UE 205 receiving or otherwise obtaining) a grant at 215. The grant may be a DCI grant 225 that schedules multiple TBs for uplink transmission by the UE 205. The DCI grant 225 may be a UE-specific grant (e.g., the grant may schedule the multi-TB uplink transmission for the UE 205). In some examples, discussed in greater detail below, the DCI grant 225 may be a group common DCI grant. The DCI grant 225 may carry or otherwise convey information identifying resources and/or parameters to be applied by the UE 205 during the multi-TB uplink transmission. The multi-TB uplink transmission scheduled by the DCI grant 225 may be via a NTN or via a TN. The multi-TB uplink transmission may include two or more TBs scheduled for a common feedback process identifier (e.g., for the same HARQ process identifier (HPID), such as a HARQ process number). That is, the two or more TBs may be scheduled for the common (e.g., the same or shared) HARQ process identifier in the DCI grant 225. The UE 205 may perform the multi-TB uplink transmission to the network entity 210 at 220 according to the DCI grant 225.

FIG. 2 illustrates a non-limiting example where the DCI grant 225 schedules or otherwise identifies three TBs for the common HPID as well as an additional TB for a different feedback process identifier. That is, the DCI grant 225 may schedule a TB 230 (e.g., TB1) scheduled for the different HARQ process identifier (e.g., HPID=0, in this example) as well as scheduling a TB 235 (e.g., TB1), a TB 240 (e.g., TB2), and a TB 245 (e.g., TB3) for the common HARQ process identifier (e.g., HPID=1). That is, the DCI grant 225 schedules, in this example, one TB for one HARQ process identifier and three TBs for another HARQ process identifier.

Accordingly, the UE 205 may identify or otherwise determine, based on the DCI grant 225, the two or more (three in this non-limiting example) TBs for the common feedback process identifier (e.g., TB1, TB2, and TB3 for HPID=1) and the additional TB (e.g., TB1) for the different feedback process identifier (e.g., HPID=0). In this example, at 220 the UE may perform the multi-TB uplink transmission to the network entity 210 by transmitting TB1 of HPID=0, and transmitting TB1, TB2, and TB3 of the HPID=1 according to the grant. As discussed above, the common feedback process identifier (e.g., HPID=1) may be associated with a HARQ process where HARQ feedback is not expected or otherwise configured (e.g., a feedback-less HARQ process) for the multi-TB uplink transmission.

Accordingly, this may enable a single grant (e.g., DCI grant 225) to schedule multiple TBs for the same HARQ process identifier (e.g., feedback process identifier) to be provided via the uplink transmission. The UE 205 may perform the multi-TB uplink transmission to the network entity 210 using the resources and/or parameters indicated or otherwise identified according to the DCI grant 225.

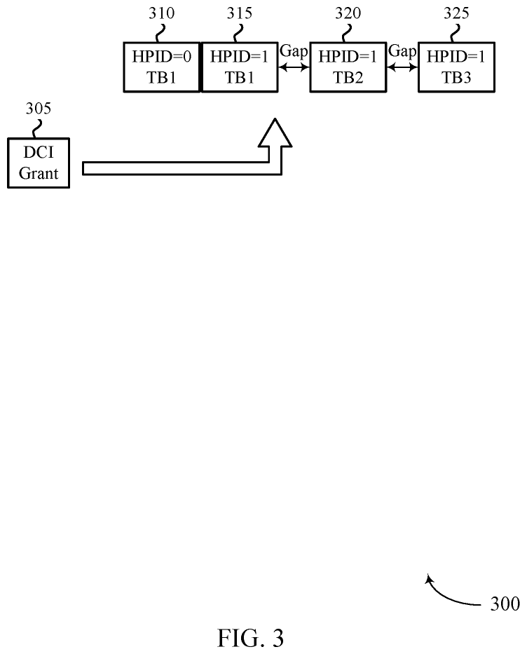

FIG. 3 shows an example of an allocation scheme 300 that supports downlink control channel capacity enhancements for NTNs in accordance with one or more aspects of the present disclosure. Allocation scheme 300 may implement aspects of wireless communications system 100 or aspect of wireless communications system 200. Aspects of allocation scheme 300 may be implemented at or implemented by a UE and/or network entity, which may be examples of the corresponding devices described herein.

Allocation scheme 300 may support the network entity allocating or otherwise scheduling a multi-TB uplink transmission by a UE where two or more of the TBs are associated with the same or common HARQ process identifier (e.g., feedback process identifier). For example, the network entity may transmit or otherwise provide to the UE a DCI grant 305 that carries or otherwise conveys information identifying resources and/or parameters to be used for communications with the UE. The DCI grant 305 may schedule or otherwise allocate a multi-TB uplink transmission to be performed by the UE. The DCI grant 305 may schedule at least two TBs for a common feedback process identifier (e.g., HPID). The DCI grant 305 may schedule a different TB for a different feedback process identifier, in some examples. In the non-limiting example illustrated in FIG. 3, the DCI grant 305 may schedule a TB 310 (e.g., TB1) for a different feedback process identifier (e.g., HIPD=0) and schedule a TB 315 (e.g., TB1), a TB 320 (e.g., TB2), and a TB 325 (e.g., TB3) for a common feedback process identifier (e.g., HPID=1). The UE may perform the multi-TB uplink transmission to the network entity by transmitting the TB 310, the TB 315, the TB 320, and the TB 325 using the uplink resources and/or parameters indicated or otherwise identified based on the DCI grant 305.

Allocation scheme 300 illustrates an example where timing gaps (e.g., gaps in the time domain) are placed (e.g., scheduled or otherwise allocated) between the two or more TBs (three TBs, in this example). In some situation, such as when the number of uplink repetitions for the scheduled NPUSCH are small, the UE may not be able to process multiple TBs (e.g., the TB 315, the TB 320, and/or the TB 325) back-to-back, such as due to processing constraints. As a result, the uplink scheduling for such cases (e.g., the DCI grant 305) may schedule some “gaps” between instances of such TBs. Whether or not the timing gap is present may depend on, for example, the number of repetitions of the uplink transmission, any specific processing time associated with a category of UE (e.g., based on UE-capability reporting, or access technology-based (eMTC/NB-IoT)). Accordingly, the UE may apply the timing gap(s) between transmissions of the two or more TBs during the multi-TB uplink transmissions to the network entity.

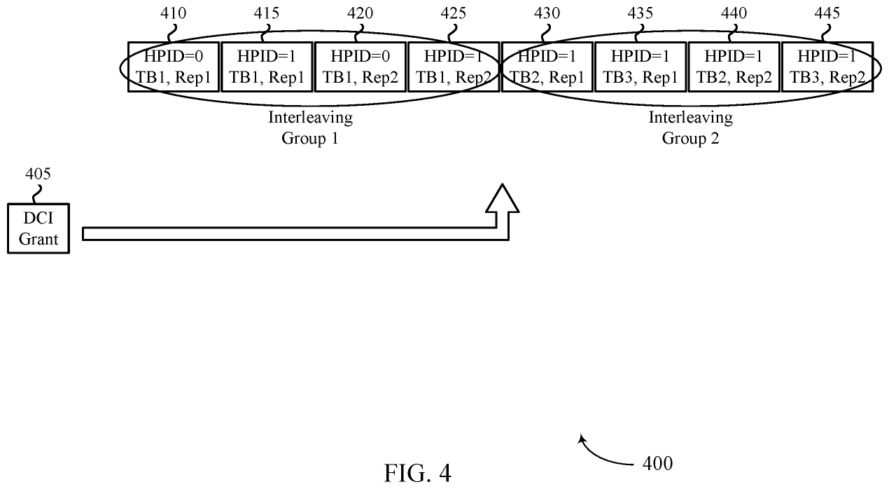

FIG. 4 shows an example of an allocation scheme 400 that supports downlink control channel capacity enhancements for NTNs in accordance with one or more aspects of the present disclosure. Allocation scheme 400 may implement aspects of wireless communications system 100 or wireless communications system 200 or aspects of allocation scheme 300. Aspects of allocation scheme 400 may be implemented at or implemented by a UE and/or network entity, which may be examples of the corresponding devices described herein.

Allocation scheme 400 may support the network entity allocating or otherwise scheduling a multi-TB uplink transmission by a UE. For example, the network entity may transmit or otherwise provide to the UE a DCI grant 405 that carries or otherwise conveys information identifying resources and/or parameters to be used for communications with the UE. The DCI grant 405 may schedule or otherwise allocate a multi-TB uplink transmission to be performed by the UE. The DCI grant 405 may schedule at least two TBs for a common feedback process identifier (e.g., HPID). The DCI grant 405 may schedule a different TB for a different feedback process identifier, in some examples.

In the non-limiting example illustrated in FIG. 4, the DCI grant 405 may schedule repetitions for one, some, or all of the TBs scheduled for the uplink transmission. For example, the DCI grant 405 may schedule a TB 410 (e.g., TB1, repetition 1) and a TB 420 (e.g., TB1, repetition 2) for a different feedback process identifier (e.g., HIPD=0, in this example) and schedule a TB 415 (e.g., TB1, repetition 1), a TB 425 (e.g., TB1, repetition 2), a TB 430 (e.g., TB2, repetition 1), a TB 435 (e.g., TB3, repetition 1), a TB 440 (e.g., TB2, repetition two), and a TB 445 (e.g., TB3, repetition two) for a common feedback process identifier (e.g., HPID=1, in this example). The UE may perform the multi-TB uplink transmission to the network entity by transmitting the TB 410, the TB 415, the TB 420, the TB 425, the TB 430, the TB 435, the TB 440, and the TB 445 using the uplink resources and/or parameters indicated or otherwise identified based on the DCI grant 405.

That is, allocation scheme 400 illustrates a non-limiting example where the repetitions of multiple TBs from the same HARQ process (as well as across different HARQ processes, in this example) are interleaved across time. This approach may improve time diversity for the uplink transmission to improve reception by the network entity. That may include the UE identifying or otherwise determining (e.g., based on the DCI grant 405) an interleaving pattern defining repetition transmissions of the two or more TBs across the time domain. In the non-limiting example illustrated in FIG. 4, this may include the UE identifying or otherwise determining two interleaving groups (e.g., interleaving group one and interleaving group two) where the repetitions of the multiple TBs are spread across the time domain for improved time diversity.

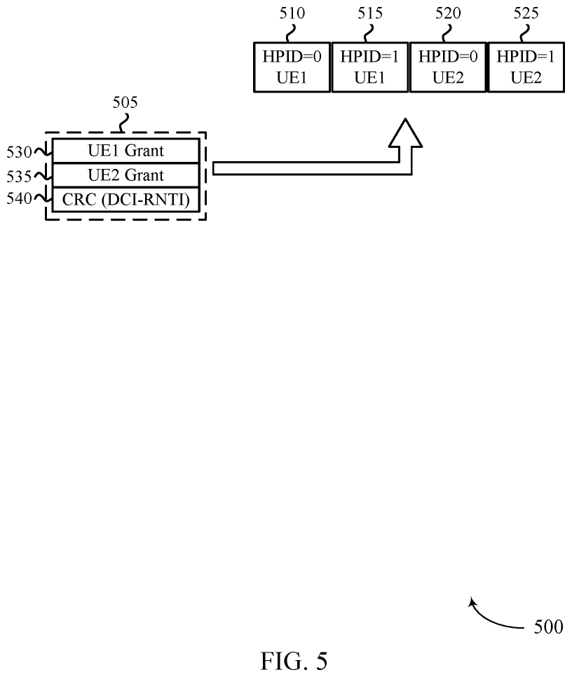

FIG. 5 shows an example of an allocation scheme 500 that supports downlink control channel capacity enhancements for NTNs in accordance with one or more aspects of the present disclosure. Allocation scheme 500 may implement aspects of wireless communications system 100 or wireless communications system 200 or aspects of allocation scheme 300 or allocation scheme 400. Aspects of allocation scheme 500 may be implemented at or implemented by a UE and/or network entity, which may be examples of the corresponding devices described herein.

Allocation scheme 500 may support the network entity allocating or otherwise scheduling an uplink transmission by a UE and at least another uplink transmission by a different UE. For example, the network entity may transmit or otherwise provide to the UE a DCI grant 505 that carries or otherwise conveys information identifying resources and/or parameters to be used for communications with the UE. The DCI grant 505 may schedule or otherwise allocate a single-TB or a multi-TB uplink transmission to be performed by the UE. In some examples, the DCI grant 505 may schedule at least two TBs for a common feedback process identifier (e.g., HPID). The DCI grant 505 may schedule a different TB for a different feedback process identifier, in some examples.

In the non-limiting example illustrated in FIG. 5, the DCI grant 505 may schedule one, two, or more TBs for uplink transmission by at least two UEs (e.g., a first UE, UE1, and a second UE, UE2). For example, the DCI grant 505 may schedule a TB(s) 510 for a first HARQ process identifier (e.g., HPID=0) and a TB(s) 515 for a second HARQ process identifier (e.g., HPID=1) for the first UE and schedule a TB(s) 520 for a first HARQ process identifier (e.g., HPID=0) and a TB(s) 525 for a second HARQ process identifier (e.g., HPID=1) for a second UE. In some aspects, any of the TB(s) 510, the TB(s) 515, the TB(s) 520, and/or the TB(s) 525 may include one TB or multiple TBs scheduled for the corresponding HARQ process identifier.

That is, allocation scheme 500 illustrates a non-limiting example of scheduling across multiple UEs. In some wireless networks, single-TB or multi-TB scheduling is supported per-UE (e.g., for a single UE), and the cyclic redundancy check (CRC) of the DCI is scrambled by the cell-radio network temporary identifier (C-RNTI) of that UE. However, the techniques described herein extend single-TB and/or multi-TB scheduling to be across pre-configured UEs, where the new DCI (e.g., the DCI grant 505) can be decoded by the multiple UEs (e.g., when the CRC is scrambled by a DCI-RNTI known to the UEs). This new DCI may be designed to have common components as well as per-UE components, and may be parsed as such by the respective UEs. For example, the DCI grant 505 may include a grant 530 for the first UE and a grant 535 for the second UE, with each grant identifying separate or shared resources and/or parameters to be applied by each UE during the uplink transmissions.

Accordingly, in some examples the DCI grant 505 may be a group common DCI grant scheduling single-TB (e.g., with repetitions) and/or multi-TB uplink transmissions for the first UE and the second UE. The first UE and/or the second UE may, based on the DCI grant 505 which carries the grant 530 and grant 535, identify or otherwise determine common UE parameter(s), UE-specific parameter(s), or both, to be applied during the multi-TB uplink transmissions from the first UE and the second UE.

In a low DCI payload scenario (e.g., for a 16-bit CRC), such a scheme provides some multiplexing gains for the (N) PDCCH, since multiple CRC bits are saved (e.g., conserved) based on each UE being scheduled individually. For example, each UE may identify or otherwise determine a shared identifier (e.g., the CRC 540 using the DCI-RNTI) that is used to decode the DCI grant 505 during the CRC procedure. The first UE may perform the uplink transmission to the network entity by transmitting the TB(s) 510 and the TB(s) 515 and the second UE may perform the uplink transmission to the network entity by transmitting the TB(s) 520 and the TB(s) 525 according to the DCI grant 505 (e.g., using the uplink resources and/or parameters indicated or otherwise identified based on the DCI grant 505).

In some aspects, the first and second UEs may be “grouped” or otherwise associated with each other based on the common or shared identifier (e.g., the DCI-RNTI). In some examples, this may include the UEs being configured via RRC signaling (e.g., initial RRC signaling and/or (pre) configuration RRC signaling) and/or via MAC-CE signaling (e.g., (re) configuration MAC-CE signaling). In some examples, additional RRC signaling may be introduced to support UE group configuration.

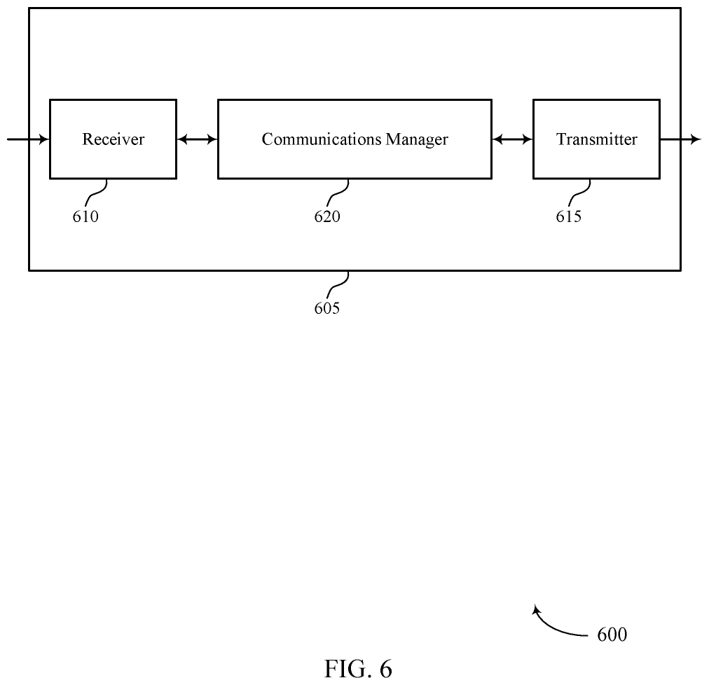

FIG. 6 shows a block diagram 600 of a device 605 that supports downlink control channel capacity enhancements for NTNs in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to downlink control channel capacity enhancements for NTNs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to downlink control channel capacity enhancements for NTNs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of downlink control channel capacity enhancements for NTNs as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 is capable of, configured to, or operable to support a means for receiving a grant scheduling a multi-TB uplink transmission by the UE, the multi-TB uplink transmission including two or more TBs associated with a common HARQ process identifier. The communications manager 620 is capable of, configured to, or operable to support a means for performing the multi-TB uplink transmission according to the grant.

Additionally, or alternatively, the communications manager 620 may support wireless communications at a UE in accordance with examples as disclosed herein. For example, the communications manager 620 is capable of, configured to, or operable to support a means for receiving a group common grant scheduling an uplink transmission of a TB for the UE and at least a second uplink transmission of a second TB for a second UE. The communications manager 620 is capable of, configured to, or operable to support a means for performing the uplink transmission according to the group common grant.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for multi-TB uplink transmissions by one or more UE for a common or shared HARQ process to conserve resources.

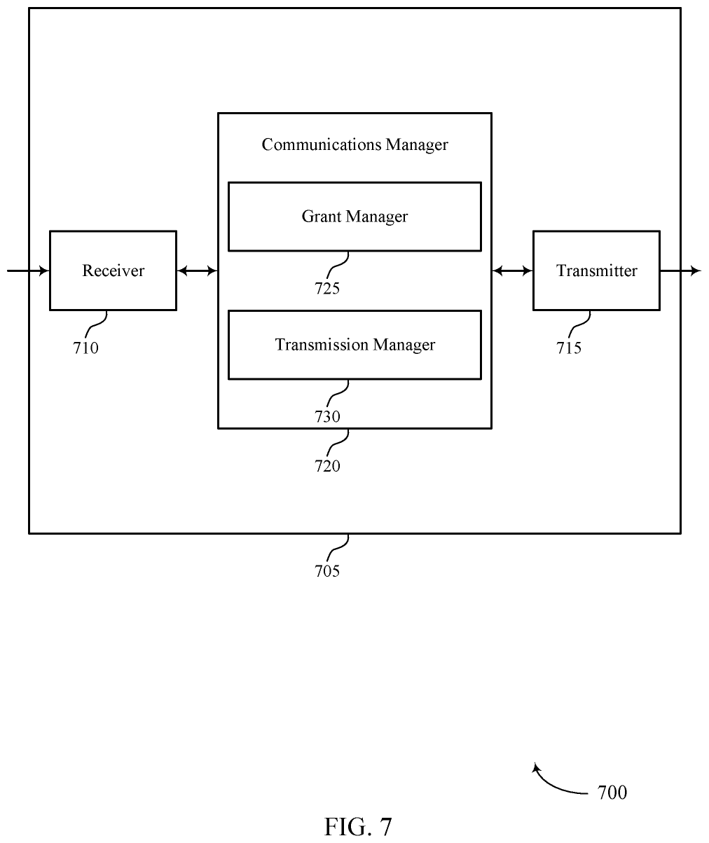

FIG. 7 shows a block diagram 700 of a device 705 that supports downlink control channel capacity enhancements for NTNs in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to downlink control channel capacity enhancements for NTNs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to downlink control channel capacity enhancements for NTNs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of downlink control channel capacity enhancements for NTNs as described herein. For example, the communications manager 720 may include a grant manager 725 a transmission manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The grant manager 725 is capable of, configured to, or operable to support a means for receiving a grant scheduling a multi-TB uplink transmission by the UE, the multi-TB uplink transmission including two or more TBs associated with a common HARQ process identifier. The transmission manager 730 is capable of, configured to, or operable to support a means for performing the multi-TB uplink transmission according to the grant.

Additionally, or alternatively, the communications manager 720 may support wireless communications at a UE in accordance with examples as disclosed herein. The grant manager 725 is capable of, configured to, or operable to support a means for receiving a group common grant scheduling an uplink transmission of a TB for the UE and at least a second uplink transmission of a second TB for a second UE. The transmission manager 730 is capable of, configured to, or operable to support a means for performing the uplink transmission according to the group common grant.

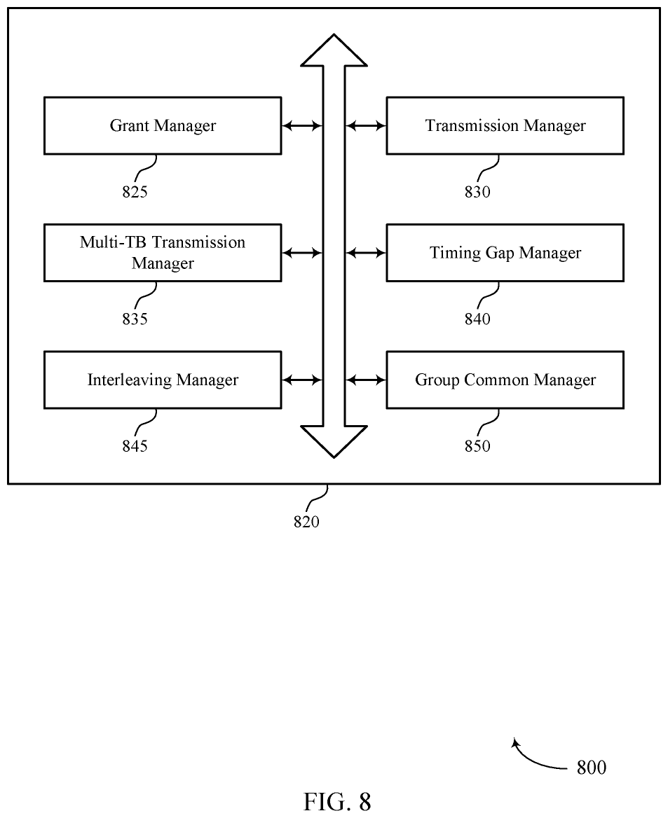

FIG. 8 shows a block diagram 800 of a communications manager 820 that supports downlink control channel capacity enhancements for NTNs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of downlink control channel capacity enhancements for NTNs as described herein. For example, the communications manager 820 may include a grant manager 825, a transmission manager 830, a multi-TB transmission manager 835, a timing gap manager 840, an interleaving manager 845, a group common manager 850, or any combination thereof. Each of these components may communicate, directly or indirectly, with one another (e.g., via one or more buses).

The communications manager 820 may support wireless communications at a UE in accordance with examples as disclosed herein. The grant manager 825 is capable of, configured to, or operable to support a means for receiving a grant scheduling a multi-TB uplink transmission by the UE, the multi-TB uplink transmission including two or more TBs associated with a common HARQ process identifier. The transmission manager 830 is capable of, configured to, or operable to support a means for performing the multi-TB uplink transmission according to the grant.

In some examples, the multi-TB transmission manager 835 is capable of, configured to, or operable to support a means for identifying, based on the grant, the two or more TBs for the common HARQ process identifier and at least an additional TB for a different HARQ process identifier.

In some examples, the timing gap manager 840 is capable of, configured to, or operable to support a means for applying, based on the grant, a time gap between successive transmissions of the two or more TBs during the multi-TB uplink transmission. In some examples, a presence, a duration, or both, of the time gap are based on at least one of a UE capability reported by the UE, an access technology associated with the multi-TB uplink transmission, a number of repetitions scheduled for at least one of the two or more TBs, or a combination thereof.

In some examples, the interleaving manager 845 is capable of, configured to, or operable to support a means for identifying, based on the grant, an interleaving pattern defined across one or more repetitions of at least the two or more TBs across a time domain, where performing the multi-TB uplink transmission includes transmitting the one or more repetitions of at least the two or more TBs according to the interleaving pattern. In some examples, the grant includes a UE-specific DCI grant to the UE.

Additionally, or alternatively, the communications manager 820 may support wireless communications at a UE in accordance with examples as disclosed herein. In some examples, the grant manager 825 is capable of, configured to, or operable to support a means for receiving a group common grant scheduling an uplink transmission of a TB for the UE and at least a second uplink transmission of a second TB for a second UE. In some examples, the transmission manager 830 is capable of, configured to, or operable to support a means for performing the uplink transmission according to the group common grant.

In some examples, the grant manager 825 is capable of, configured to, or operable to support a means for identifying, based on the group common grant, one or more parameters common to at least the UE and the second UE, one or more UE-specific parameters, or both, for the uplink transmission by the UE and the second uplink transmission by the second UE.

In some examples, the group common manager 850 is capable of, configured to, or operable to support a means for determining a configured shared identifier associated with at least the UE and the second UE. In some examples, the group common manager 850 is capable of, configured to, or operable to support a means for decoding the group common grant based on the configured shared identifier.

In some examples, the group common manager 850 is capable of, configured to, or operable to support a means for receiving at least one of an initial RRC signaling, a reconfiguration RRC signaling, a MAC-CE signaling, or a combination thereof, that configures the configured shared identifier.

In some examples, the uplink transmission scheduled for the UE, the second uplink transmission scheduled for the second UE, or both, include a multi-TB uplink transmission comprising two or more TBs, the multi-TB uplink transmission associated with a common HARQ process identifier.

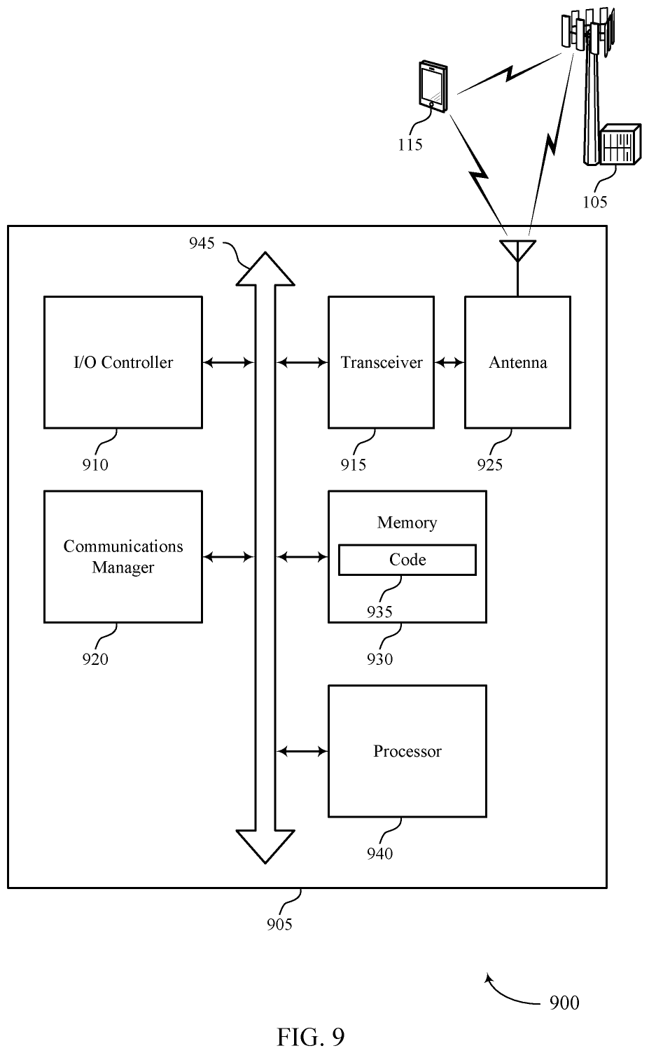

FIG. 9 shows a diagram of a system 900 including a device 905 that supports downlink control channel capacity enhancements for NTNs in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting downlink control channel capacity enhancements for NTNs). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 is capable of, configured to, or operable to support a means for receiving a grant scheduling a multi-TB uplink transmission by the UE, the multi-TB uplink transmission including two or more TBs associated with a common HARQ process identifier. The communications manager 920 is capable of, configured to, or operable to support a means for performing the multi-TB uplink transmission according to the grant.

Additionally, or alternatively, the communications manager 920 may support wireless communications at a UE in accordance with examples as disclosed herein. For example, the communications manager 920 is capable of, configured to, or operable to support a means for receiving a group common grant scheduling an uplink transmission of a TB for the UE and at least a second uplink transmission of a second TB for a second UE. The communications manager 920 is capable of, configured to, or operable to support a means for performing the uplink transmission according to the group common grant.

By including or configuring the communications manager 920 in accordance with examples as described herein, the device 905 may support techniques for multi-TB uplink transmissions by one or more UE for a common or shared HARQ process to conserve resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of downlink control channel capacity enhancements for NTNs as described herein, or the processor 940 and the memory 930 may be otherwise configured to perform or support such operations.

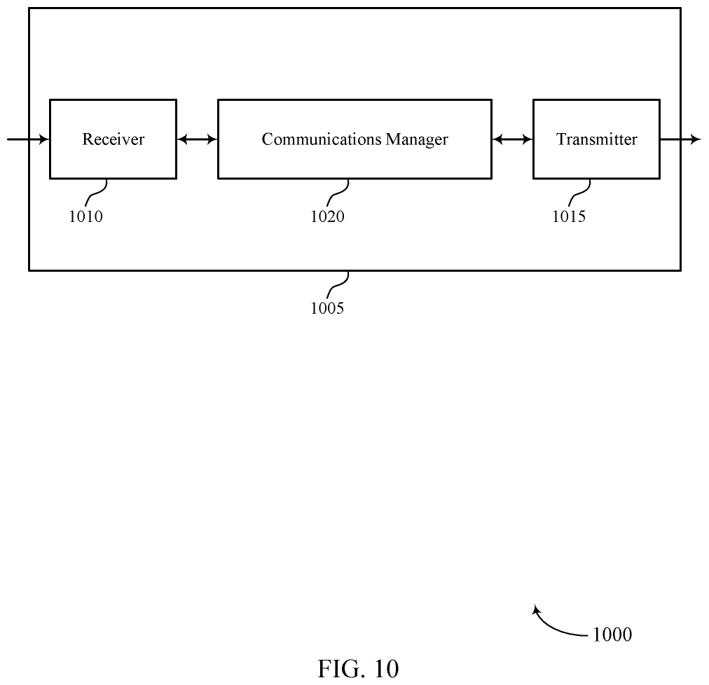

FIG. 10 shows a block diagram 1000 of a device 1005 that supports downlink control channel capacity enhancements for NTNs in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of downlink control channel capacity enhancements for NTNs as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 is capable of, configured to, or operable to support a means for transmitting, to a UE, a grant scheduling a multi-TB uplink transmission by the UE, the multi-TB uplink transmission including two or more TBs associated with a common HARQ process identifier. The communications manager 1020 is capable of, configured to, or operable to support a means for receiving the multi-TB uplink transmission from the UE according to the grant.

Additionally, or alternatively, the communications manager 1020 may support wireless communications at a network entity in accordance with examples as disclosed herein. For example, the communications manager 1020 is capable of, configured to, or operable to support a means for transmitting a group common grant scheduling an uplink transmission of a TB for a UE and at least a second uplink transmission of a second TB for a second UE. The communications manager 1020 is capable of, configured to, or operable to support a means for receiving the uplink transmission and the second uplink transmission according to the group common grant.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for multi-TB uplink transmissions by one or more UE for a common or shared HARQ process to conserve resources.

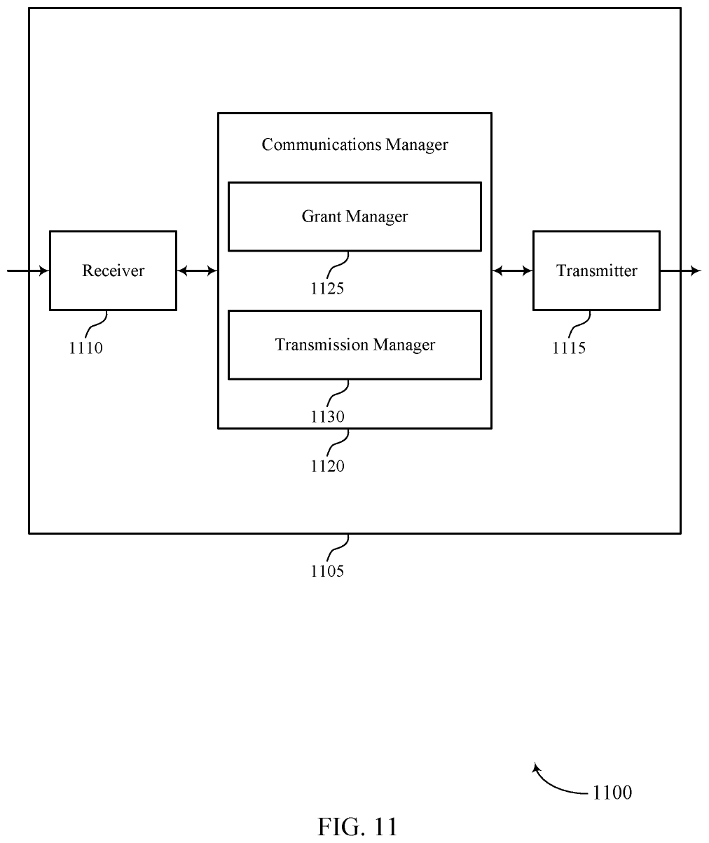

FIG. 11 shows a block diagram 1100 of a device 1105 that supports downlink control channel capacity enhancements for NTNs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of downlink control channel capacity enhancements for NTNs as described herein. For example, the communications manager 1120 may include a grant manager 1125 a transmission manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The grant manager 1125 is capable of, configured to, or operable to support a means for transmitting, to a UE, a grant scheduling a multi-TB uplink transmission by the UE, the multi-TB uplink transmission including two or more TBs associated with a common HARQ process identifier. The transmission manager 1130 is capable of, configured to, or operable to support a means for receiving the multi-TB uplink transmission from the UE according to the grant.

Additionally, or alternatively, the communications manager 1120 may support wireless communications at a network entity in accordance with examples as disclosed herein. The grant manager 1125 is capable of, configured to, or operable to support a means for transmitting a group common grant scheduling an uplink transmission of a TB for a UE and at least a second uplink transmission of a second TB for a second UE. The transmission manager 1130 is capable of, configured to, or operable to support a means for receiving the uplink transmission and the second uplink transmission according to the group common grant.

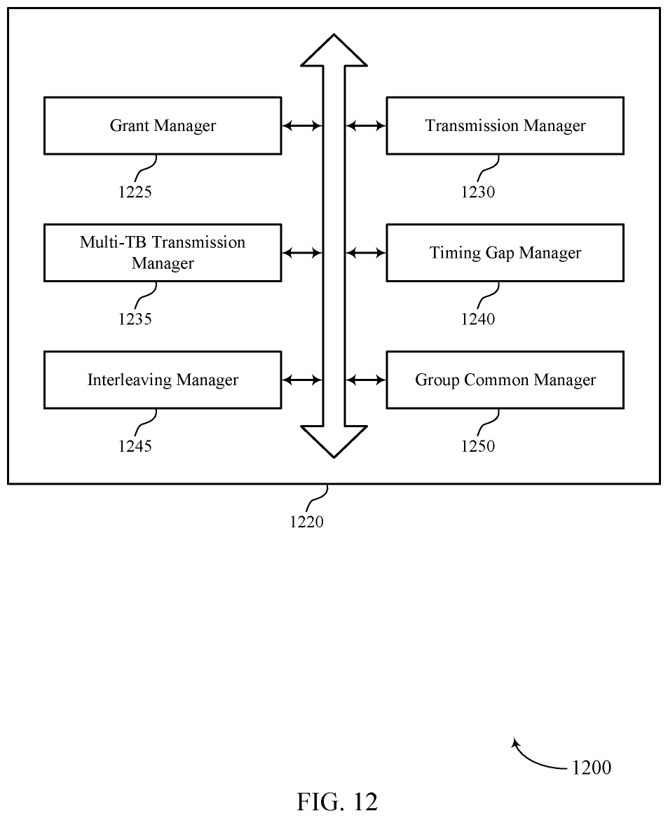

FIG. 12 shows a block diagram 1200 of a communications manager 1220 that supports downlink control channel capacity enhancements for NTNs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of downlink control channel capacity enhancements for NTNs as described herein. For example, the communications manager 1220 may include a grant manager 1225, a transmission manager 1230, a multi-TB transmission manager 1235, a timing gap manager 1240, an interleaving manager 1245, a group common manager 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The grant manager 1225 is capable of, configured to, or operable to support a means for transmitting, to a UE, a grant scheduling a multi-TB uplink transmission by the UE, the multi-TB uplink transmission including two or more TBs associated with a common HARQ process identifier. The transmission manager 1230 is capable of, configured to, or operable to support a means for receiving the multi-TB uplink transmission from the UE according to the grant.

In some examples, the multi-TB transmission manager 1235 is capable of, configured to, or operable to support a means for indicating, in the grant, the two or more TBs for the common HARQ process identifier and at least an additional TB for a different HARQ process identifier.

In some examples, the timing gap manager 1240 is capable of, configured to, or operable to support a means for indicating, in the grant, a time gap between UE transmissions of the two or more TBs during the multi-TB uplink transmission.

In some examples, a presence, a duration, or both, of the time gap are based on at least one of a UE capability reported by the UE, an access technology associated with the multi-TB uplink transmission, a number of repetitions scheduled for at least one of the two or more TBs, or a combination thereof.

In some examples, the interleaving manager 1245 is capable of, configured to, or operable to support a means for indicating, in the grant, an interleaving pattern defined across one or more repetitions of at least the two or more TBs across a time domain, where receiving the multi-TB uplink transmission includes receiving the one or more repetitions of at least the two or more TBs according to the interleaving pattern. In some examples, the grant includes a UE-specific DCI grant to the UE.

Additionally, or alternatively, the communications manager 1220 may support wireless communications at a network entity in accordance with examples as disclosed herein. In some examples, the grant manager 1225 is capable of, configured to, or operable to support a means for transmitting a group common grant scheduling an uplink transmission of a TB for a UE and at least a second uplink transmission of a second TB for a second UE. In some examples, the transmission manager 1230 is capable of, configured to, or operable to support a means for receiving the uplink transmission and the second uplink transmission according to the group common grant.

In some examples, the multi-TB transmission manager 1235 is capable of, configured to, or operable to support a means for indicating, in the group common grant, one or more parameters common to at least the UE and the second UE, one or more UE-specific parameters, or both, for the uplink transmission by the UE and the second uplink transmission by the second UE.

In some examples, the group common manager 1250 is capable of, configured to, or operable to support a means for determining a configured shared identifier associated with at least the UE and the second UE. In some examples, the group common manager 1250 is capable of, configured to, or operable to support a means for applying the configured shared identifier when transmitting the group common grant.

In some examples, the group common manager 1250 is capable of, configured to, or operable to support a means for transmitting at least one of an initial RRC signaling, a reconfiguration RRC signaling, a MAC-CE signaling, or a combination thereof, that configures the configured shared identifier.

In some examples, the uplink transmission scheduled for the UE, the second uplink transmission scheduled for the second UE, or both, include a multi-TB uplink transmission comprising two or more TBs, the multi-TB uplink transmission associated with a common HARQ process identifier.

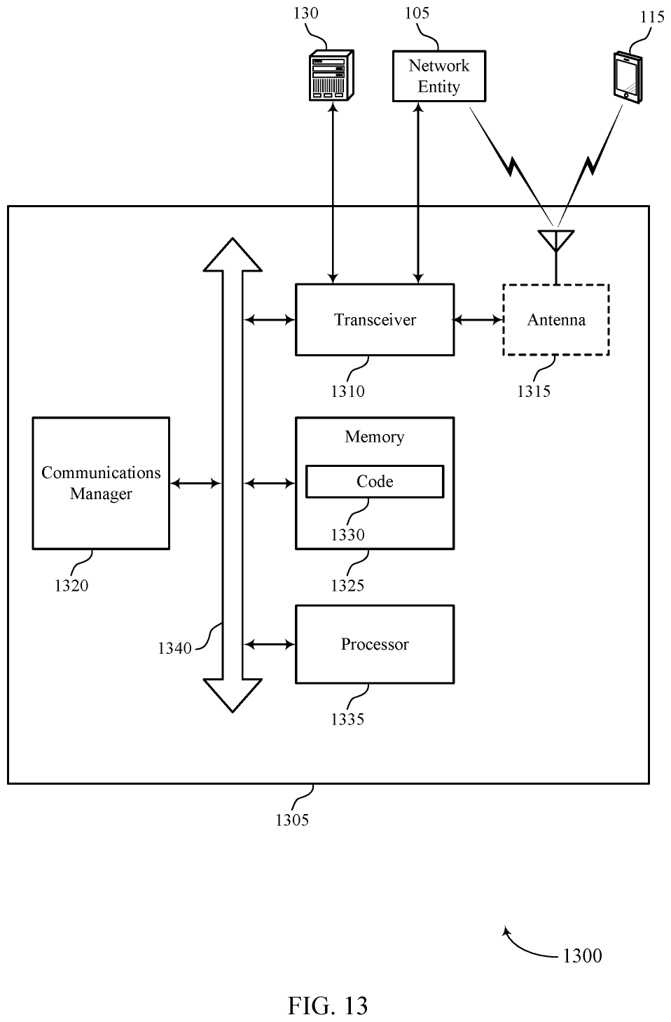

FIG. 13 shows a diagram of a system 1300 including a device 1305 that supports downlink control channel capacity enhancements for NTNs in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting downlink control channel capacity enhancements for NTNs). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 is capable of, configured to, or operable to support a means for transmitting, to a UE, a grant scheduling a multi-TB uplink transmission by the UE, the multi-TB uplink transmission including two or more TBs associated with a common HARQ process identifier. The communications manager 1320 is capable of, configured to, or operable to support a means for receiving the multi-TB uplink transmission from the UE according to the grant.

Additionally, or alternatively, the communications manager 1320 may support wireless communications at a network entity in accordance with examples as disclosed herein. For example, the communications manager 1320 is capable of, configured to, or operable to support a means for transmitting a group common grant scheduling an uplink transmission of a TB for a UE and at least a second uplink transmission of a second TB for a second UE. The communications manager 1320 is capable of, configured to, or operable to support a means for receiving the uplink transmission and the second uplink transmission according to the group common grant.

By including or configuring the communications manager 1320 in accordance with examples as described herein, the device 1305 may support techniques for multi-TB uplink transmissions by one or more UE for a common or shared HARQ process to conserve resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of downlink control channel capacity enhancements for NTNs as described herein, or the processor 1335 and the memory 1325 may be otherwise configured to perform or support such operations.

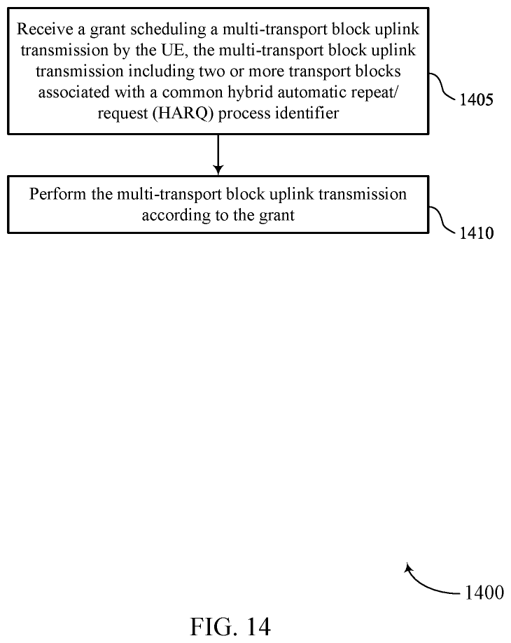

FIG. 14 shows a flowchart illustrating a method 1400 that supports downlink control channel capacity enhancements for NTNs in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving a grant scheduling a multi-TB uplink transmission by the UE, the multi-TB uplink transmission including two or more TBs associated with a common HARQ process identifier. The operations of 1405 may be performed in accordance with examples as disclosed herein. In some examples, aspects of the operations of 1405 may be performed by a grant manager 825 as described with reference to FIG. 8.

At 1410, the method may include performing the multi-TB uplink transmission according to the grant. The operations of 1410 may be performed in accordance with examples as disclosed herein. In some examples, aspects of the operations of 1410 may be performed by a transmission manager 830 as described with reference to FIG. 8.

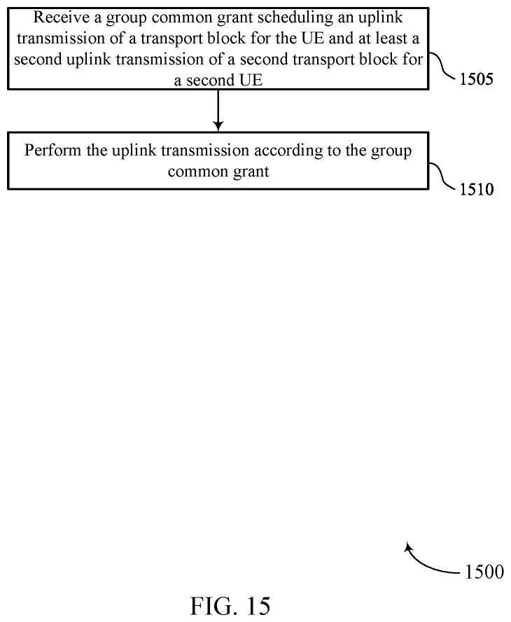

FIG. 15 shows a flowchart illustrating a method 1500 that supports downlink control channel capacity enhancements for NTNs in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving a group common grant scheduling an uplink transmission of a TB for the UE and at least a second uplink transmission of a second TB for a second UE. The operations of 1505 may be performed in accordance with examples as disclosed herein. In some examples, aspects of the operations of 1505 may be performed by a grant manager 825 as described with reference to FIG. 8.

At 1510, the method may include performing the uplink transmission according to the group common grant. The operations of 1510 may be performed in accordance with examples as disclosed herein. In some examples, aspects of the operations of 1510 may be performed by a transmission manager 830 as described with reference to FIG. 8.

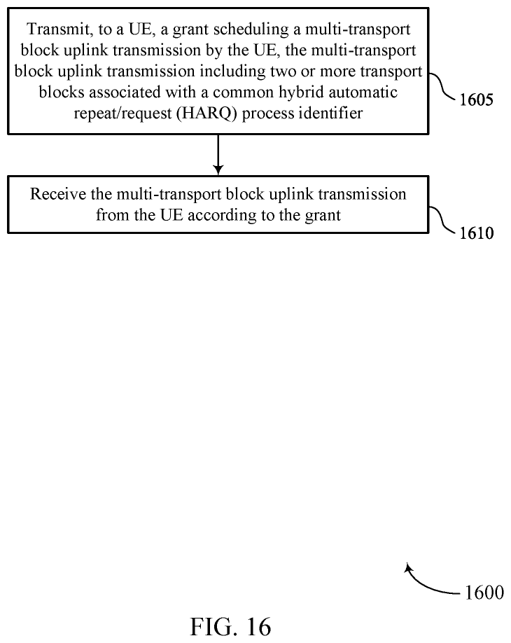

FIG. 16 shows a flowchart illustrating a method 1600 that supports downlink control channel capacity enhancements for NTNs in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1605, the method may include transmitting, to a UE, a grant scheduling a multi-TB uplink transmission by the UE, the multi-TB uplink transmission including two or more TBs associated with a common HARQ process identifier. The operations of 1605 may be performed in accordance with examples as disclosed herein. In some examples, aspects of the operations of 1605 may be performed by a grant manager 1225 as described with reference to FIG. 12.

At 1610, the method may include receiving the multi-TB uplink transmission from the UE according to the grant. The operations of 1610 may be performed in accordance with examples as disclosed herein. In some examples, aspects of the operations of 1610 may be performed by a transmission manager 1230 as described with reference to FIG. 12.

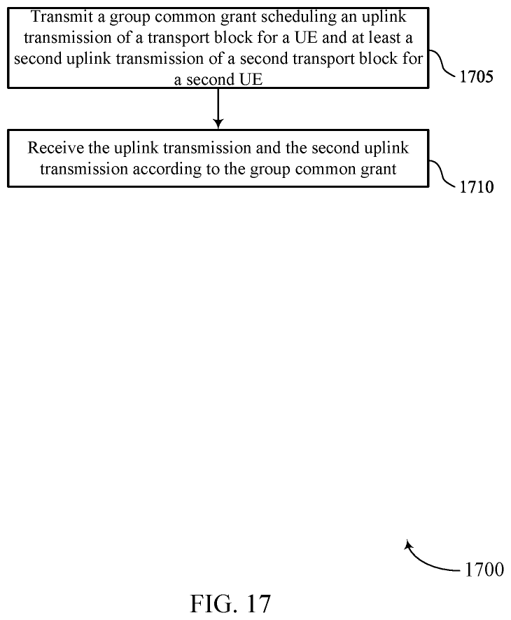

FIG. 17 shows a flowchart illustrating a method 1700 that supports downlink control channel capacity enhancements for NTNs in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1705, the method may include transmitting a group common grant scheduling an uplink transmission of a TB for a UE and at least a second uplink transmission of a second TB for a second UE. The operations of 1705 may be performed in accordance with examples as disclosed herein. In some examples, aspects of the operations of 1705 may be performed by a grant manager 1225 as described with reference to FIG. 12.

At 1710, the method may include receiving the uplink transmission and the second uplink transmission according to the group common grant. The operations of 1710 may be performed in accordance with examples as disclosed herein. In some examples, aspects of the operations of 1710 may be performed by a transmission manager 1230 as described with reference to FIG. 12.

The following provides an overview of aspects of the present disclosure:

Aspect 1: A method for wireless communications at a UE, comprising: receiving a grant scheduling a multi-TB uplink transmission by the UE, the multi-TB uplink transmission comprising two or more TBs associated with a common HARQ process identifier; and performing the multi-TB uplink transmission according to the grant.

Aspect 2: The method of aspect 1, further comprising: identifying, based at least in part on the grant, the two or more TBs for the common HARQ process identifier and at least an additional TB for a different HARQ process identifier.

Aspect 3: The method of any of aspects 1 through 2, further comprising: applying, based at least in part on the grant, a time gap between successive transmissions of the two or more TBs during the multi-TB uplink transmission.

Aspect 4: The method of aspect 3, wherein a presence, a duration, or both, of the time gap are based on at least one of a UE capability reported by the UE, an access technology associated with the multi-TB uplink transmission, a number of repetitions scheduled for at least one of the two or more TBs, or a combination thereof.

Aspect 5: The method of any of aspects 1 through 4, further comprising: identifying, based at least in part on the grant, an interleaving pattern defined across one or more repetitions of at least the two or more TBs across a time domain, wherein performing the multi-TB uplink transmission comprises transmitting the one or more repetitions of at least the two or more TBs according to the interleaving pattern.

Aspect 6: The method of any of aspects 1 through 5, wherein the grant comprises a UE-specific DCI grant to the UE.

Aspect 7: A method for wireless communications at a UE, comprising: receiving a group common grant scheduling an uplink transmission of a TB for the UE and at least a second uplink transmission of a second TB for a second UE; and performing the uplink transmission according to the group common grant.

Aspect 8: The method of aspect 7, further comprising: identifying, based at least in part on the group common grant, one or more parameters common to at least the UE and the second UE, one or more UE-specific parameters, or both, for the uplink transmission by the UE and the second uplink transmission by the second UE.

Aspect 9: The method of any of aspects 7 through 8, further comprising: determining a configured shared identifier associated with at least the UE and the second UE; and decoding the group common grant based at least in part on the configured shared identifier.

Aspect 10: The method of aspect 9, further comprising: receiving at least one of an initial RRC signaling, a reconfiguration RRC signaling, a MAC-CE signaling, or a combination thereof, that configures the configured shared identifier.

Aspect 11: The method of any of aspects 7 through 10, wherein the uplink transmission scheduled for the UE, the second uplink transmission scheduled for the second UE, or both, comprise a multi-TB uplink transmission comprising two or more TBs, the multi-TB uplink transmission associated with a common HARQ process identifier.

Aspect 12: A method for wireless communications at a network entity, comprising: transmitting, to a UE, a grant scheduling a multi-TB uplink transmission by the UE, the multi-TB uplink transmission comprising two or more TBs associated with a common HARQ process identifier; and receiving the multi-TB uplink transmission from the UE according to the grant.

Aspect 13: The method of aspect 12, further comprising: indicating, in the grant, the two or more TBs for the common HARQ process identifier and at least an additional TB for a different HARQ process identifier.

Aspect 14: The method of any of aspects 12 through 13, further comprising: indicating, in the grant, a time gap between UE transmissions of the two or more TBs during the multi-TB uplink transmission.

Aspect 15: The method of aspect 14, wherein a presence, a duration, or both, of the time gap are based on at least one of a UE capability reported by the UE, an access technology associated with the multi-TB uplink transmission, a number of repetitions scheduled for at least one of the two or more TBs, or a combination thereof.

Aspect 16: The method of any of aspects 12 through 15, further comprising: indicating, in the grant, an interleaving pattern defined across one or more repetitions of at least the two or more TBs across a time domain, wherein receiving the multi-TB uplink transmission comprises receiving the one or more repetitions of at least the two or more TBs according to the interleaving pattern.

Aspect 17: The method of any of aspects 12 through 16, wherein the grant comprises a UE-specific DCI grant to the UE.

Aspect 18: A method for wireless communications at a network entity, comprising: transmitting a group common grant scheduling an uplink transmission of a TB for a UE and at least a second uplink transmission of a second TB for a second UE; and receiving the uplink transmission and the second uplink transmission according to the group common grant.

Aspect 19: The method of aspect 18, further comprising: indicating, in the group common grant, one or more parameters common to at least the UE and the second UE, one or more UE-specific parameters, or both, for the uplink transmission by the UE and the second uplink transmission by the second UE.

Aspect 20: The method of any of aspects 18 through 19, further comprising: determining a configured shared identifier associated with at least the UE and the second UE; and applying the configured shared identifier when transmitting the group common grant.

Aspect 21: The method of aspect 20, further comprising: transmitting at least one of an initial RRC signaling, a reconfiguration RRC signaling, a MAC-CE signaling, or a combination thereof, that configures the configured shared identifier.

Aspect 22: The method of any of aspects 18 through 21, wherein the uplink transmission scheduled for the UE, the second uplink transmission scheduled for the second UE, or both, comprise a multi-TB uplink transmission comprising two or more TBs, the multi-TB uplink transmission associated with a common HARQ process identifier.

Aspect 23: An apparatus for wireless communications at a UE, comprising a processor; memory coupled with the processor; and instructions stored in the memory and executable by the processor to cause the apparatus to perform a method of any of aspects 1 through 6.

Aspect 24: An apparatus for wireless communications at a UE, comprising at least one means for performing a method of any of aspects 1 through 6.

Aspect 25: A non-transitory computer-readable medium storing code for wireless communications at a UE, the code comprising instructions executable by a processor to perform a method of any of aspects 1 through 6.

Aspect 26: An apparatus for wireless communications at a UE, comprising a processor; memory coupled with the processor; and instructions stored in the memory and executable by the processor to cause the apparatus to perform a method of any of aspects 7 through 11.

Aspect 27: An apparatus for wireless communications at a UE, comprising at least one means for performing a method of any of aspects 7 through 11.

Aspect 28: A non-transitory computer-readable medium storing code for wireless communications at a UE, the code comprising instructions executable by a processor to perform a method of any of aspects 7 through 11.

Aspect 29: An apparatus for wireless communications at a network entity, comprising a processor; memory coupled with the processor; and instructions stored in the memory and executable by the processor to cause the apparatus to perform a method of any of aspects 12 through 17.

Aspect 30: An apparatus for wireless communications at a network entity, comprising at least one means for performing a method of any of aspects 12 through 17.

Aspect 31: A non-transitory computer-readable medium storing code for wireless communications at a network entity, the code comprising instructions executable by a processor to perform a method of any of aspects 12 through 17.

Aspect 32: An apparatus for wireless communications at a network entity, comprising a processor; memory coupled with the processor; and instructions stored in the memory and executable by the processor to cause the apparatus to perform a method of any of aspects 18 through 22.

Aspect 33: An apparatus for wireless communications at a network entity, comprising at least one means for performing a method of any of aspects 18 through 22.

Aspect 34: A non-transitory computer-readable medium storing code for wireless communications at a network entity, the code comprising instructions executable by a processor to perform a method of any of aspects 18 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive a grant scheduling a multi-transport block uplink transmission by the UE, the multi-transport block uplink transmission comprising two or more transport blocks associated with a common hybrid automatic repeat/request (HARQ) process identifier; and
perform the multi-transport block uplink transmission according to the grant.

2. The apparatus of claim 1, wherein the instructions are further executable by the processor to cause the apparatus to:
identify, based at least in part on the grant, the two or more transport blocks for the common HARQ process identifier and at least an additional transport block for a different HARQ process identifier.

3. The apparatus of claim 1, wherein the instructions are further executable by the processor to cause the apparatus to:
apply, based at least in part on the grant, a time gap between successive transmissions of the two or more transport blocks during the multi-transport block uplink transmission.

4. The apparatus of claim 3, wherein a presence, a duration, or both, of the time gap are based on at least one of a UE capability reported by the UE, an access technology associated with the multi-transport block uplink transmission, a number of repetitions scheduled for at least one of the two or more transport blocks, or a combination thereof.

5. The apparatus of claim 1, wherein the instructions are further executable by the processor to cause the apparatus to:
identify, based at least in part on the grant, an interleaving pattern defined across one or more repetitions of at least the two or more transport blocks across a time domain, wherein performing the multi-transport block uplink transmission comprises transmitting the one or more repetitions of at least the two or more transport blocks according to the interleaving pattern.

6. The apparatus of claim 1, wherein the grant comprises a UE-specific downlink control information grant to the UE.

7. An apparatus for wireless communications at a user equipment (UE), comprising:
a processor;
memory coupled with the processor; and
instructions stored in the memory and executable by the processor to cause the apparatus to:
receive a group common grant scheduling an uplink transmission of a transport block for the UE and at least a second uplink transmission of a second transport block for a second UE; and
perform the uplink transmission according to the group common grant.

8. The apparatus of claim 7, wherein the instructions are further executable by the processor to cause the apparatus to:
identify, based at least in part on the group common grant, one or more parameters common to at least the UE and the second UE, one or more UE-specific parameters, or both, for the uplink transmission by the UE and the second uplink transmission by the second UE.

9. The apparatus of claim 7, wherein the instructions are further executable by the processor to cause the apparatus to:
determine a configured shared identifier associated with at least the UE and the second UE; and
decode the group common grant based at least in part on the configured shared identifier.

10. The apparatus of claim 9, wherein the instructions are further executable by the processor to cause the apparatus to:
receive at least one of an initial radio resource control (RRC) signaling, a reconfiguration RRC signaling, a medium access control-control element (MAC-CE) signaling, or a combination thereof, that configures the configured shared identifier.

11. The apparatus of claim 7, wherein the uplink transmission scheduled for the UE, the second uplink transmission scheduled for the second UE, or both, comprise a multi-transport block uplink transmission comprising two or more transport blocks, the multi-transport block uplink transmission associated with a common hybrid automatic repeat/request (HARQ) process identifier.

12. A method for wireless communications at a user equipment (UE), comprising:
receiving a grant scheduling a multi-transport block uplink transmission by the UE, the multi-transport block uplink transmission comprising two or more transport blocks associated with a common hybrid automatic repeat/request (HARQ) process identifier; and
performing the multi-transport block uplink transmission according to the grant.

13. The method of claim 12, further comprising:
identifying, in the grant, the two or more transport blocks for the common HARQ process identifier and at least an additional transport block for a different HARQ process identifier.

14. The method of claim 12, further comprising:
applying, in the grant, a time gap between successive transmissions of the two or more transport blocks during the multi-transport block uplink transmission.

15. The method of claim 14, wherein a presence, a duration, or both, of the time gap are based on at least one of a UE capability reported by the UE, an access technology associated with the multi-transport block uplink transmission, a number of repetitions scheduled for at least one of the two or more transport blocks, or a combination thereof.

16. The method of claim 12, further comprising:
identifying, based at least in part on the grant, an interleaving pattern defined across one or more repetitions of at least the two or more transport blocks across a time domain, wherein performing the multi-transport block uplink transmission comprises transmitting the one or more repetitions of at least the two or more transport blocks according to the interleaving pattern.

17. The method of claim 12, wherein the grant comprises a UE-specific downlink control information grant to the UE.
